(19) United States
(12) Patent Application Publication
(10) Pub. No.: US 2014/0176278 A1
(43) Pub. Date: Jun. 26, 2014

(54) INDUCTOR AND MANUFACTURING METHOD THEREOF

(71) Applicant: SAMSUNG ELECTRO-MECHANICS CO., LTD., Suwon (KR)

(72) Inventors: Dong Hwan LEE, Suwon (KR); Seung Wook PARK, Suwon (KR); Christian ROMERO, Suwon (KR); Young Do KWEON, Suwon (KR); Jin Gu KIM, Suwon (KR)

(73) Assignee: SAMSUNG ELECTRO-MECHANICS CO., LTD., Suwon (KR)

(21) Appl. No.: 13/841,107

(22) Filed: Mar. 15, 2013

(30) Foreign Application Priority Data
Dec. 24, 2012 (KR) 10-2012-0152231

(51) Int. Cl. H01F 27/29; H01F 41/02

(52) U.S. Cl. CPC H01F 27/29; H01F 41/02
USPC 336/192; 29/606

(57) ABSTRACT

There is provided an inductor, including a circuit board having an input and output terminal formed on a lower surface thereof, a connection pad formed on an upper surface thereof, and a via electrically connecting the input and output terminal and the connection pad, a coil having both ends joined to the connection pad and wound in a circular or a polygonal spiral shape in a longitudinal direction of the circuit board so as to have one or more turns, and a body stacked on the circuit board such that the coil and the connection pad are embedded therein.

### CROSS-REFERENCE TO RELATED APPLICATIONS

This application claims the priority of Korean Patent Application No. 10-2012-0152231 filed on Dec. 24, 2012, in the Korean Intellectual Property Office, the disclosure of which is incorporated herein by reference.

### BACKGROUND OF THE INVENTION

1. Field of the Invention

The present invention relates to an inductor and a manufacturing method thereof.

2. Description of the Related Art

As a high frequency filter removing high frequency noise emitted from digital devices such as computers, an inductor has been widely used. As such an inductor, there is a coil multilayer inductor. Meanwhile, in the coil multilayer inductor, a chip body is configured according to multilayered ceramic layers and coil conductors between the ceramic layers may be connected by using a through hole formed in the ceramic layers. In addition, after forming the coil as a looped curve, the initial end and the termination end of the coil are connected to an external electrode, respectively.

Meanwhile, high inductance and low resistance have been required in a high frequency filter. In general, inductance is proportional to the amount of turns of the coil and inversely proportional to a length thereof.

However, there may be a limitation in that the multilayered inductor may have a low self resonance frequency due to parasite capacitance generated by capacitive coupling between patterns of the initial end and the termination end.

Furthermore, since the multilayered inductor requires various constituent elements for connecting the coil and an external power source, a manufacturing yield may deteriorate and the multilayered inductor may be unsuitable for a mass production.

As a result, the development of technology capable of improving manufacturing yields of an inductor while improving the efficiency thereof is urgently required.

In Patent Document 1, the multilayered inductor is disclosed.

### RELATED ART DOCUMENT

[Patent Document 1] Korean Patent Laid-Open Publication No. 2011-0094333

### SUMMARY OF THE INVENTION

An aspect of the present invention provides an inductor having high inductance and a manufacturing method thereof.

Another aspect of the present invention also provides an inductor capable in which EMI noise due to leakage flux is reduced, and a manufacturing method thereof.

Another aspect of the present invention provides an inductor capable of improving a manufacturing yield and a manufacturing method thereof.

According to an aspect of the present invention, there is provided an inductor, including: a circuit board having an input and output terminal formed on a lower surface thereof, a connection pad formed on an upper surface thereof, and a via electrically connecting the input and output terminal and the connection pad; a coil having both ends joined to the connection pad and wound in a circular or a polygonal spiral shape in a longitudinal direction of the circuit board so as to have one or more turns; and a body stacked on the circuit board such that the coil and the connection pad are embedded therein.

A solder resist may be coated on an area of the connection pad except for a region in which the coil is joined thereto.

The both ends of the coil may have lead parts formed thereon, the lead parts being joined to the connection pad and being extended such that the coil is spaced apart from the circuit board by a predetermined distance.

The body may be formed of one of a dielectric material, a magnetic material, and a complex including a dielectric or a magnetic powder.

The coil may have a wound portion disposed in a center of the body.

According to another aspect of the present invention, there is provided a manufacturing method of an inductor, the method including: preparing a substrate part including a plurality of unit circuit boards; installing a coil on each of the plurality of unit circuit boards; stacking a body on the substrate part such that the coil is embedded therein; curing the body; and integrally cutting the unit circuit board on which the coil is installed and the body to separate the plurality of respective unit circuit boards and the body into a plurality of inductors.

Each of the unit circuit board may have an input and output terminal formed on a lower surface thereof, a connection pad formed on an upper surface thereof, and a via electrically connecting the input and output terminal and the connection pad.

A solder resist may be coated on an area of the connection pad except for a region in which the coil is joined thereto.

The coil may be wound to have a circular or polygonal spiral shape in a longitudinal direction of the circuit board.

The stacking of the body may be performed by fixing the substrate part having the coil installed thereon to a mold and then, filling the mold with one of a dielectric material, a magnetic material, and a complex including a dielectric or a magnetic powder.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating an inductor according to an embodiment of the present invention;

FIG. 2 is a plan view illustrating the inductor according to the embodiment of the present invention;

FIG. 3 is a front view illustrating the inductor according to the embodiment of the present invention;

FIG. 4 is a graph illustrating inductance characteristics of an inductor according to the related art;

FIG. 5 is a graph illustrating inductance characteristics of the inductor according to the embodiment of the present invention;

FIG. 6 is a perspective view illustrating an inductor according to another embodiment of the present invention;

FIG. 7 is a plan view illustrating the inductor according to another embodiment of the present invention;

FIG. 8 is a front view illustrating the inductor according to another embodiment of the present invention;

FIG. 9 is a graph illustrating inductance characteristics of the inductor according to another embodiment of the present invention;

FIG. 10 is a perspective view illustrating an inductor according to another embodiment of the present invention; and

FIGS. 11 through 15 are process diagrams illustrating a manufacturing method of an inductor according to an embodiment of the present invention.

### DETAILED DESCRIPTION OF THE INVENTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

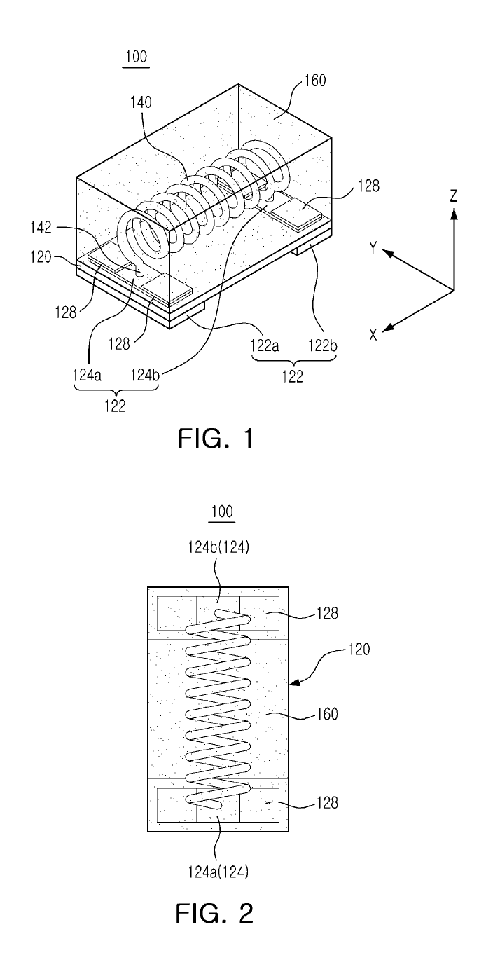

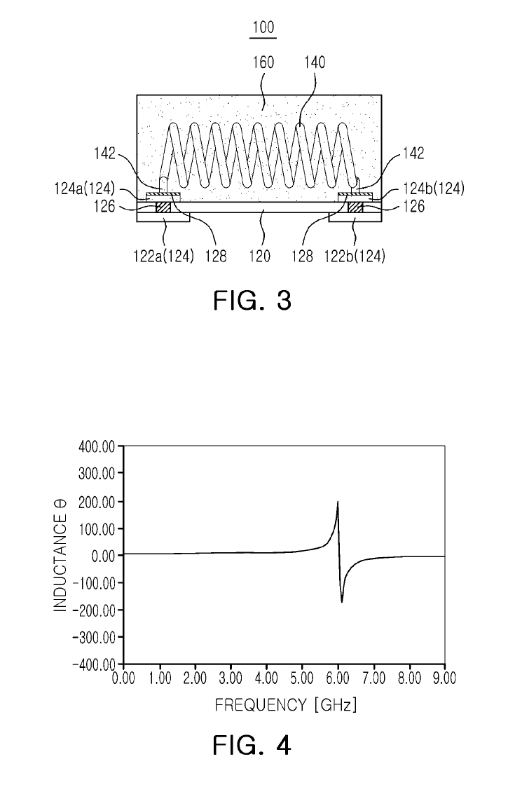

FIG. 1 is a perspective view illustrating an inductor according to an embodiment of the present invention. FIG. 2 is a plan view illustrating the inductor according to the embodiment of the present invention. FIG. 3 is a front view illustrating the inductor according to the embodiment of the present invention.

Referring to FIGS. 1 to 3, an inductor 100 according to an embodiment of the present invention may include a circuit board 120, a coil 140, and a body 160 as an example.

The circuit board 120 maybe formed as a resin substrate formed of glass epoxy resin or the like, and may include an input and output terminal 122, a connection pad 124, and a via 126.

The input and output terminal 122 is formed on a lower surface of the circuit board 120 and may be electrically connected to an external power source when being installed in an electronic device or the like. That is, the input and output terminal 122 may include an input terminal 122a and an output terminal 122b.

Meanwhile, the input terminal 122a and the output terminal 122b may be formed at ends of the circuit board 120 in a longitudinal direction of the circuit board 120. That is, the input terminal 122a and the output terminal 122b may be spaced apart from each other so as to suppress the generation of short circuits.

However, in the embodiment, a case in which the input terminal 122a and the output terminal 122b are formed at both ends of the circuit board 120 in the longitudinal direction is described as an example, but is not limited thereto.

Here, when first defining terms for directions, the longitudinal direction of the circuit board 120 refers to an X direction in FIG. 1, while a width direction of the circuit board 120 refers to a Y direction in FIG. 1. Further, a thickness direction of the circuit board 120 refers to a Z direction in FIG. 1.

The connection pad 124 may be formed on an upper surface of the circuit board 120, and may be disposed in a position corresponding to the input and output terminal 122. In addition, the connection pad 124 may include an input connection pad 124a connected to the input terminal 122a and an output connection pad 124b connected to the output terminal 122b.

That is, the connection pad 124 may be formed at ends on the upper surface of the circuit board 120 in the longitudinal direction of the circuit board 120.

Meanwhile, a solder resist 128 may be coated on the connection pad 124. That is, the solder resist 128 may be coated on an area of the connection pad 124, except for a region thereof in which the coil 140 of the connection pad 124 is joined thereto.

The via 126 serves to electrically connect the input and output terminal 122 and the connection pad 124 and may be formed in the thickness direction of the circuit board 120. In addition, the via 126 is disposed within the circuit board 120 so as not to be exposed outside thereof.

Both ends of the coil 140 are joined to the connection pad 124, and the coil 140 may be wound to have a circular or polygonal spiral shape in the longitudinal direction of the circuit board 120.

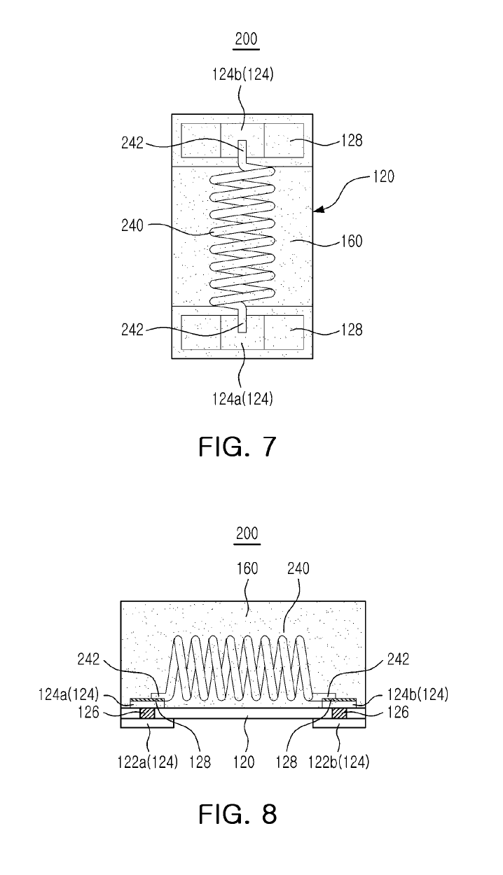

Meanwhile, the coil 140 maybe formed as a metallic line formed of silver (Ag), copper (Cu), or an alloy thereof, and at the time of the manufacturing thereof, a coil part 130 (see FIG. 7) to which a plurality of coils 140 are connected is manufactured and then cut to be formed as a unit coil 140.

Further, lead parts 142, joined to the connection pad 124 and extended such that the coil 140 is spaced apart from the circuit board 120 by a predetermined distance, maybe formed on both ends of the coil 140.

The lead parts 142 may be vertically formed such that distal ends thereof are disposed in the thickness direction.

That is, the lead parts 142 may be joined to the connection pad 124 by welding or the like.

Meanwhile, in the drawings, a case in which the coil 140 has a circular spiral shape is illustrated as an example, but it is not limited thereto, and the coil 140 may have various spiral shapes such as a quadrangular spiral shape or the like.

In addition, since the lead parts 142 are formed to have a predetermined length in the thickness direction, the coil 140 may be spaced apart from the circuit board 120. Accordingly, a sufficient path for magnetic flux may be provided and loss of the magnetic flux may be reduced. As a result, since the coil 140 may be spaced apart from the circuit board 120 by a predetermined distance, to thereby acquire higher inductance and reduce electromagnetic interference (EMI) noise due to leakage flux.

Meanwhile, the wound portion of the coil 140 may be disposed in the center of the body 160. That is, the coil 140 may be disposed in the body 160 such that a center line of the coil 140 and a center line of the body 160 are adjacent to each other or coincide with each other.

The body 160 may be stacked on the circuit board 120 such that the coil 140 and the connection pad 124 are embedded therein. In addition, the body 160 may be formed of one of a dielectric material, a magnetic material, and a complex including a dielectric or a magnetic powder.

Meanwhile, the body 160 may be formed by a method of fixing the circuit board 120 on which the coil 140 is installed to a mold and then filling the mold with one of a dielectric material, a magnetic material, and a complex including a dielectric or a magnetic powder in slurry form having a predetermined viscosity.

Thereafter, the body 160 may be cured at a predetermined temperature.

As described above, according to the structure in which capacitances generated between adjacent wound parts due to the coil 140 having a spiral shape in the longitudinal direction of the circuit board 120 are connected in series, total equivalent parasitic capacitance is decreased, and as a result, a self resonance frequency (SRF) may be increased.

Furthermore, it is possible to acquire a higher degree of inductance by reducing leakage flux and reduce electromagnetic interference (EMI) noise due to leakage flux.

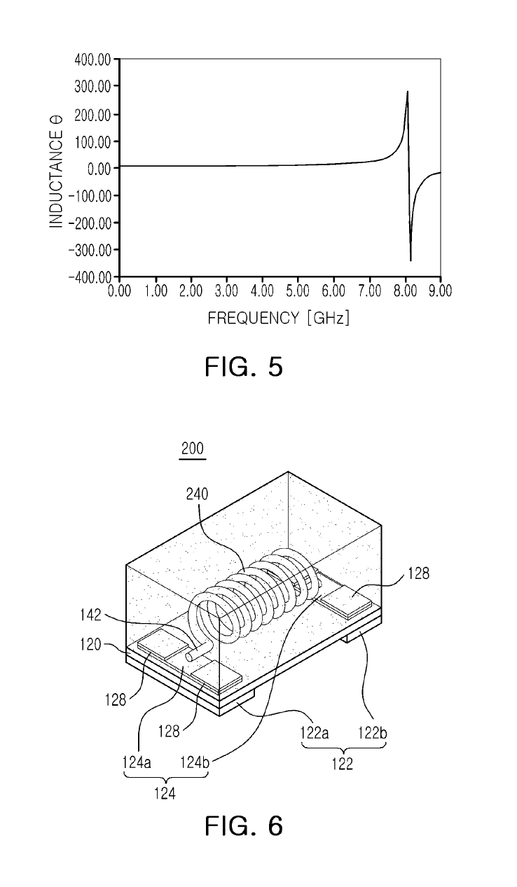

That is, referring to FIGS. 4 and 5, as compared with a multilayered inductor according to the related art, it may be confirmed that the inductor 100 according to the embodiment of the present invention has a higher self resonance frequency (SRF).

Hereinafter, an inductor according to another embodiment of the present invention will be described with reference to the accompanying drawings. However, the same constituent elements as the constituent elements described above use the same reference numerals, and the detailed description thereof will be substituted for the description.

FIG. 6 is a perspective view illustrating an inductor according to another embodiment of the present invention. FIG. 7 is a plan view illustrating the inductor according to another embodiment of the present invention. FIG. 8 is a front view illustrating the inductor according to another embodiment of the present invention.

Referring to FIGS. 6 to 8, an inductor 200 according to another embodiment of the present invention may include the circuit board 120, a coil 240, and the body 160 as an example.

Meanwhile, since the circuit board 120 and the body 160 have the same configuration as the circuit board 120 and the body 160 provided in the inductor 100 according to the aforementioned embodiment of the present invention, a detailed description thereof will be omitted.

Further, since the coil 240 has the same configuration as the coil 140 provided in the inductor 100 according to the aforementioned embodiment of the present invention except for lead parts 242, a detailed description thereof will be omitted and hereinafter, only the lead parts 242 will be described.

The lead parts 242 may be formed such that distal ends thereof are extended in the longitudinal direction. Accordingly, coupling force between the lead parts 242 and the connection pad 124 may be increased, and the coil 240 may be more stably installed on the circuit board 120.

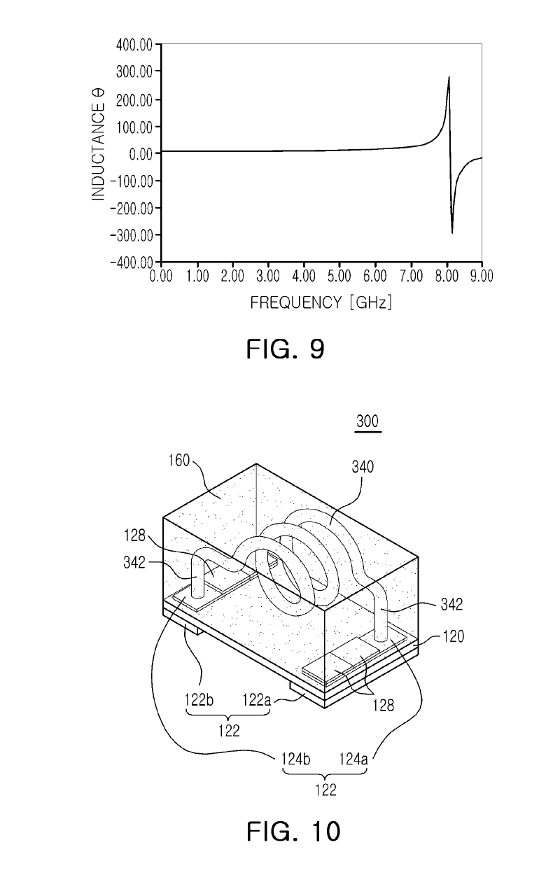

In addition, referring to FIGS. 4 and 9, as compared with a multilayered inductor according to the related art, it may be confirmed that the inductor 200 according to another embodiment of the present invention has a higher self resonance frequency (SRF).

Hereinafter, an inductor according to yet another embodiment of the present invention will be described with reference to the accompanying drawings. However, the same constituent elements as the constituent elements described above use the same reference numerals, and the detailed description thereof will be substituted for the description.

FIG. 10 is a perspective view illustrating an inductor according to another embodiment of the present invention.

Referring to FIG. 10, an inductor 300 according to another embodiment of the present invention may include the circuit board 120, a coil 340, and the body 160 as an example.

Meanwhile, since the circuit board 120 and the body 160 have the same configuration as the circuit board 120 and the body 160 provided in the inductor 100 according to the foregoing embodiment of the present invention, herein, a detailed description will be omitted and substituted for the description.

Both ends of the coil 340 are joined to the connection pad 124, and the coil 140 may be wound to have a circular or polygonal spiral shape in the width direction of the circuit board 120. Meanwhile, since the coil 340 is wound in the width direction of the circuit board 120, an area of the body 160 disposed inside the coil 340 may be increased.

Accordingly, although the coil 340 is wound to have a small number of turns, high inductance may be implemented therein.

In other words, even in the case in which the coil 340 is wound to have a larger diameter, such that the coil 340 is wound to have the smaller number of turns, high inductance may be implemented therein.

Meanwhile, the amount of turns of the coil 340 has one or more turns and is not limited to the winding number (that is, amount of turns) of the coil 340. In other words, it is not limited to the winding number of the coil 340 illustrated in the drawings, and the winding number of the coil 340 may be increased or decreased.

Hereinafter, a manufacturing method of an inductor according to an embodiment of the present invention will be described with reference to the accompanying drawings.

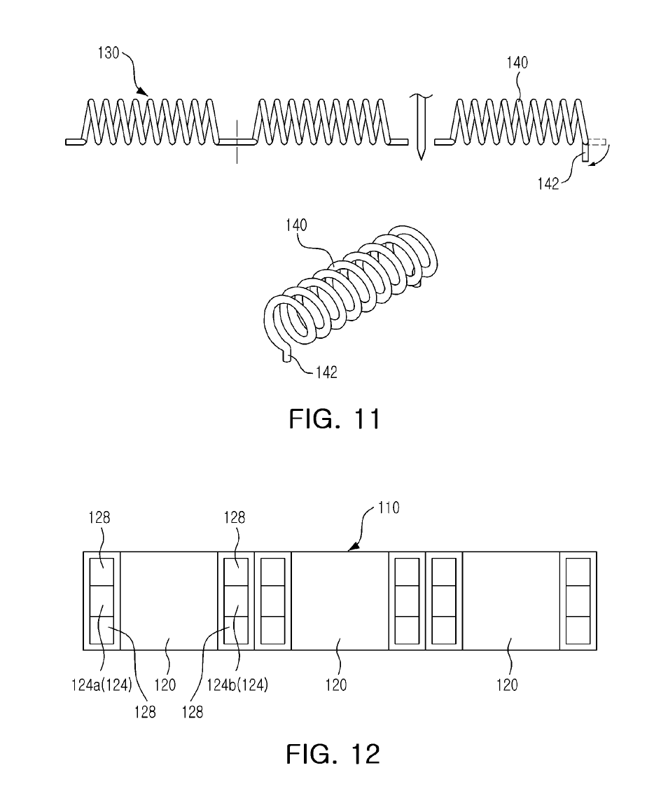

FIGS. 11 through 15 are process diagrams illustrating a manufacturing method of an inductor according to an exemplary embodiment of the present invention.

First, referring to FIG. 11, the coil 140 is formed by cutting the coil part 130 manufactured in such a manner that a plurality of unit coils 140 are connected to each other. In this case, both ends of the coil 140 are curved to form the lead parts 142.

The lead parts 142 may be curved once such that the distal ends thereof are disposed in the thickness direction, or may be formed such that the distal ends thereof are disposed in the longitudinal direction.

Meanwhile, the coil 140 may be wound to have a circular or polygonal spiral shape in the longitudinal direction of the circuit board 120.

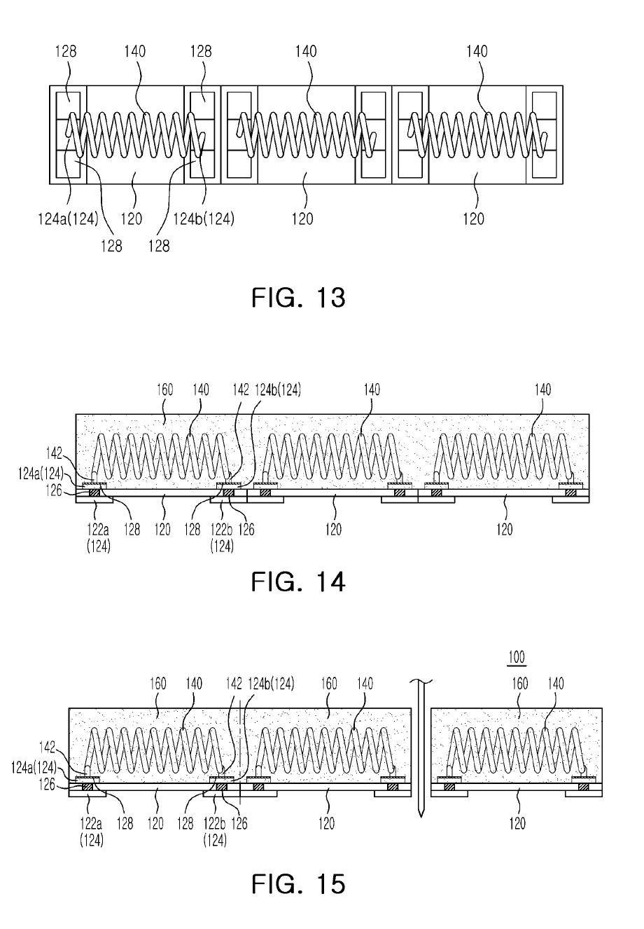

Thereafter, as illustrated in FIG. 12, a substrate part 110 including a plurality of unit circuit boards 120 is prepared, and as illustrated in FIG. 13, the coil 140 may be installed on each of the plurality of unit circuit boards 120 of the substrate part 110. In this case, the lead parts 142 of the coil 140 may be joined to the connection pad 124 of the circuit board 120 through welding.

Next, as illustrated in FIG. 14, the body 160 is stacked on the substrate part 110 having the coil 140 installed thereon, in such a manner that the coil 140 is embedded therein. In addition, the body 160 may be stacked by a method of fixing the substrate part 110 having the coil 140 installed thereon to a mold and then filling the mold with one of a dielectric material, a magnetic material, and a complex including a dielectric or a magnetic powder.

Next, the body 160 maybe cured. The curing of the body 160 may be performed by heat or ultraviolet light. However, it is not limited thereto, and the curing of the body 160 may be performed by various methods.

Next, as illustrated in FIG. 15, the circuit board 120 on which the coil 100 is installed and the body 160 are integrally cut, such that the circuit board 120 and the body 160 may be separated as a plurality of inductors 100. In this case, the cutting may be performed by a dicing or a slicing machine.

As described above, since the inductor 100 may be manufactured by mounting the coil 140 on the substrate part 110 to which the input and output terminal 122 and the connection pad 124 are electrically connected through the via 126, the inductor 100 maybe manufactured without a separate process for electrically connecting the input and output terminal 122 and the connection pad 124, and as a result, a manufacturing yield thereof may be improved.

Furthermore, the inductor 100 may be manufactured by a method of joining the plurality of coils on the unit circuit boards 120 of the substrate part 110, and as a result, a mass production may be achieved. As a result, it is possible to further improve the manufacturing yield.

As set forth above, according to embodiments of the invention, since a coil is disposed in the center of a body, EMI noise due to leakage flux can be reduced.

Further, higher inductance can be acquired by reducing parasite capacitance through a coil having a spiral shape in a longitudinal direction of the circuit board.

Furthermore, a manufacturing yield can be improved simultaneously with achieving mass production by manufacturing an inductor using a process of stacking the coil and the body on the substrate part including a plurality of unit circuit boards.

While the present invention has been shown and described in connection with the embodiments, it will be apparent to those skilled in the art that modifications and variations can be made without departing from the spirit and scope of the invention as defined by the appended claims.

What is claimed is:

1. An inductor, comprising:
a circuit board having an input and output terminal formed on a lower surface thereof, a connection pad formed on an upper surface thereof, and a via electrically connecting the input and output terminal and the connection pad;
a coil having both ends joined to the connection pad and wound in a circular or a polygonal spiral shape in a longitudinal direction of the circuit board so as to have one or more turns; and
a body stacked on the circuit board such that the coil and the connection pad are embedded therein.

2. The inductor of claim 1, wherein a solder resist is coated on an area of the connection pad except for a region in which the coil is joined thereto.

3. The inductor of claim 1, wherein the both ends of the coil have lead parts formed thereon, the lead parts being joined to the connection pad and being extended such that the coil is spaced apart from the circuit board by a predetermined distance.

4. The inductor of claim 1, wherein the body is formed of one of a dielectric material, a magnetic material, and a complex including a dielectric or a magnetic powder.

5. The inductor of claim 1, wherein the coil has a wound portion disposed in a center of the body.

6. A manufacturing method of an inductor, comprising:
preparing a substrate part including a plurality of unit circuit boards;
installing a coil on each of the plurality of unit circuit boards;
stacking a body on the substrate part such that the coil is embedded therein;
curing the body; and
integrally cutting the unit circuit board on which the coil is installed and the body to separate the plurality of respective unit circuit boards and the body into a plurality of inductors.

7. The manufacturing method of claim 6, wherein each of the unit circuit board has an input and output terminal formed on a lower surface thereof, a connection pad formed on an upper surface thereof, and a via electrically connecting the input and output terminal and the connection pad.

8. The manufacturing method of claim 6, wherein a solder resist is coated on an area of the connection pad except for a region in which the coil is joined thereto.

9. The manufacturing method of claim 6, wherein the coil is wound to have a circular or polygonal spiral shape in a longitudinal direction of the circuit board.

10. The manufacturing method of claim 6, wherein the stacking of the body is performed by fixing the substrate part having the coil installed thereon to a mold and then, filling the mold with one of a dielectric material, a magnetic material, and a complex including a dielectric or a magnetic powder.
